(19) United States
(12) Patent Application Publication
(10) Pub. No.: US 2023/0031825 A1
(43) Pub. Date: Feb. 2, 2023

(54) METHOD AND SENSOR SYSTEM FOR MERGING SENSOR DATA AND VEHICLE HAVING A SENSOR SYSTEM FOR MERGING SENSOR DATA

(71) Applicant: Continental Autonomous Mobility Germany GmbH, Ingolstadt (DE)

(72) Inventor: Matthias Schreier, Frankfurt am Main (DE)

(73) Assignee: Continental Autonomous Mobility Germany GmbH, Ingolstadt (DE)

(21) Appl. No.: 17/816,808

(22) Filed: Aug. 2, 2022

(30) Foreign Application Priority Data
Aug. 2, 2021 (DE) 10 2021 208 349.8

(51) Int. Cl. G06K 9/62

(52) U.S. Cl. CPC G06K 9/6288; G06K 9/6277

(57) ABSTRACT

The present disclosure relates to a method for merging sensor data. A sensor data set including first sensor data is provided. Furthermore, the first sensor data is analyzed, and a first sensor result is generated, the first sensor result being based on the analysis of the first sensor data. Moreover, a first sensor model is generated, the first sensor model being associated with the first sensor result and being dependent on a first uncertainty data set. The first uncertainty data set is a subset of the sensor data set. A second sensor result and a second sensor model are also generated, the second sensor model being associated with the second sensor result. Lastly, the first sensor result and the second sensor result are merged to form a fusion result, wherein the merging is performed on the basis of the first sensor model and the second sensor model.

### CROSS REFERENCE TO RELATED APPLICATION

The present application claims the benefit and/or priority of German application 10 2021 208 349.8, filed Aug. 2, 2021, the content of which is incorporated by reference herein.

### FIELD OF THE INVENTION

The invention relates to a method and a sensor system for merging sensor data and to a vehicle having a sensor system for merging sensor data. The method and the sensor system may be used in a wide variety of areas in which various sensor data has to be merged. In particular, the method and the sensor system may be used to merge sensor data to form an environment model, in particular of a robot or a vehicle.

### BACKGROUND

In many areas, various sensor data is merged to form a fusion result by means of sensor models. For example, in vehicles, in particular in semi-autonomous or autonomous vehicles, the sensor data from various sensors, such as a camera, a radar and a lidar, is merged to form a vehicle environment model. The vehicle environment model includes, for example, the course of the road and the positions of stationary objects, such as buildings and trees, as well as the positions of other road users.

The sensor models describe uncertainties, for example in the detection of objects. These uncertainties can be, for example, uncertainties in the position of the objects, uncertainties in the type of the objects, detection uncertainties, that is, whether an object is detected at all, or false alarm probabilities. The sensor data is merged taking into account the sensor models, that is, the larger the uncertainty of sensor data, the lower the weighting of this sensor data when merging.

### SUMMARY

The object of the present disclosure is to provide a method and a sensor system for merging sensor data, which determine sensor models in an improved manner. This object is achieved by the subject matter of the independent claims. Further developments are set out in the dependent claims and the following description.

One aspect of the present disclosure relates to a method for merging sensor data. In the method, a sensor data set including first sensor data is provided. The sensor data set is in particular sensor data acquired by sensors at regular intervals or continuously, the data being merged by the method. For example, this data is acquired when a vehicle is traveling and is merged in real time.

The first sensor data is analyzed by means of a first analysis unit. The analysis of the first sensor data includes object detection, for example. On the basis of the analysis of the first sensor data, the first analysis unit generates a first sensor result that includes, for example, the type and position of the detected objects. However, the first sensor result may also include raw data from sensors. Furthermore, a first sensor model is generated by the first analysis unit. The first sensor model is associated with the first sensor result. The first sensor model describes uncertainties, for example in the detection of objects. These uncertainties may be, for example, uncertainties in the position of the objects, uncertainties in the type of the objects, detection uncertainties, that is, whether an object is detected at all, or false alarm probabilities. In particular, a different uncertainty may be associated with different parts of the first sensor result, for example different detected objects. The first sensor model is dependent on a first uncertainty data set, which is a subset of the sensor data set. Thus, the first sensor model is not static but is determined dynamically on the basis of sensor data. Thus, the sensor model is continuously adapted to the current situation detected by sensors. A dynamic, situation-adaptive sensor model of this kind describes the uncertainties and probabilities in the detection better than a static sensor model because the dynamic model processes even more information.

By means of a second analysis unit, a second sensor result is generated. This second sensor result may also be based on the analysis of the first sensor data but may also be based on the analysis of other sensor data. Furthermore, a second sensor model is generated by the second analysis unit, the sensor model being associated with the second sensor result. The second sensor model also describes uncertainties, for example in the detection of objects. These uncertainties may be, for example, uncertainties in the position of the objects, uncertainties in the type of the objects, detection uncertainties, that is, whether an object is detected at all, or false alarm probabilities. In particular, a different uncertainty may be associated with different parts of the second sensor result, for example, different detected objects.

The thus obtained first sensor result and second sensor result are merged by a fusion unit to form a fusion result. The merging is performed on the basis of the first sensor model and the second sensor model. Since the first sensor model is dynamic and situation-adaptive and was thus improved in comparison with a static sensor model, the fusion result is also improved.

In some embodiments, the first sensor data includes raw data from a first sensor. Thus, raw data provided by the first sensor is analyzed, and the first sensor result is generated therefrom. This analysis is performed, for example, by means of artificial intelligence, in particular by means of machine learning such as deep neural networks trained with corresponding training data. For example, objects in the environment of a vehicle or a robot are detected from the raw data. Alternatively or additionally, the first sensor data includes processed raw data from at least the first sensor. For example, the first sensor data itself may be results of an object detection. Using already processed raw data allows for greater modularity and lower complexity. Furthermore, processed raw data ensures better testability. Moreover, a lower bandwidth is required to transmit the processed raw data. Furthermore, processed raw data is less susceptible to miscalibration and time stamp errors. As another example, an occupancy grid may have been generated from raw data from the sensors. An occupancy grid of this kind includes the occupancy of spatial points by objects, for example stationary objects or other road users. This occupancy grid may in turn be analyzed, for example to identify objects in the occupancy grid. Thus, the occupancy grid just generated from raw data from sensors corresponds to the first sensor data. Thus, a wide variety of data, from raw data to elaborately processed data, may be used as the first sensor data, which makes the method particularly flexible for many applications.

In some embodiments, the sensor data set includes second sensor data. This second sensor data is analyzed by the second analysis unit such that the second sensor result is based on the analysis of the second sensor data. The second sensor data may include raw data from a second sensor. This analysis of this raw data is performed, for example, by means of artificial intelligence, in particular by means of machine learning such as deep neural networks trained with corresponding training data. For example, objects in the environment of a vehicle or a robot are detected from the raw data. Alternatively or additionally, the second sensor data may include processed raw data from at least the second sensor. Thus, the second sensor data itself may also be results of an object detection. The advantages of using already processed raw data are similar to the advantages of using processed raw data for the first sensor data.

In some embodiments, the first sensor and/or the second sensor are a camera, a radar, a lidar and/or an ultrasonic sensor. Sensors of this kind may directly contribute to determining the environment of, for example, a robot or a vehicle. However, other sensors are also conceivable, for example a digital map from which information about the course of the road may be obtained.

In some embodiments, the first uncertainty data set is different from the first sensor data. Thus, the first sensor model is not determined on the basis of the first sensor data used to generate the first sensor result. For example, sensor data that gives a significant indication of the uncertainty of the first sensor result may be used to determine the first sensor model. Thus, the determination of the first sensor model is improved by using further sensor data.

In some embodiments, the first uncertainty data set includes raw data from the first sensor. In this case, the raw data from the first sensor provides more information than, for example, the already processed raw data from the first sensor. Alternatively or additionally, the first uncertainty data set may include raw data from the second sensor. Thus, information obtained from the second sensor may be used to determine the first sensor model. Alternatively or additionally, the first uncertainty data set may also include processed raw data from at least the first sensor and/or from at least the second sensor. Preferably, the raw data is then processed in a way that improves the determination of the first sensor model.

In some embodiments, the second sensor model is dependent on a second uncertainty data set. In this case, the second uncertainty data set is a subset of the sensor data set, in particular a subset that is different from the second sensor data. Thus, the determination of the second sensor model is identical to the determination of the first sensor model, meaning that the second sensor model is also dynamic and situation-adaptive and thus improved. The merging of the first sensor result with the second sensor result may thus be performed even better. The second uncertainty data set may include raw data from the first sensor, raw data from the second sensor, and/or processed raw data from at least the first sensor and/or the second sensor.

In some embodiments, the sensor model includes a statistical measurement uncertainty. Alternatively or additionally, the sensor model includes a classification uncertainty, a detection probability, and/or a false alarm rate. These different characteristics of the sensor model may be used individually or in combination by the fusion unit to merge the first and second sensor results.

In some embodiments, the generation of the first sensor model and/or the second sensor model is performed by means of an algorithm that is dependent on the first uncertainty data set and/or the second uncertainty data set. An algorithm of this kind is in particular advantageous if the first and/or second uncertainty data set includes processed raw data that allows a direct conclusion about the first and/or second sensor model, respectively.

In some embodiments, the generation of the first sensor model and/or the second sensor model is performed using a trained first machine learning system and/or a trained second machine learning system, respectively. This is in particular advantageous if the first and/or second uncertainty data set includes raw data from sensors. The machine learning system may then also learn relationships that are not obvious from the sensor data. The learning of the machine learning system may take place as supervised learning. For example, data sets that have been created using a reference sensor system and/or data sets that have been provided with labels are used as training data sets. In particular, the learning of the machine learning system is performed offline, while the trained machine learning system is then applied online to current sensor data. The inference of the sensor model is thus performed online on the basis of current uncertainty data sets and the offline-trained machine learning system.

In some embodiments, the first machine learning system and/or the second machine learning system is a deep neural network. This is characterized in that hidden relationships between the uncertainty data set and the uncertainty measure are also well detected. Alternatively, probabilistic graphical models, Bayesian networks or Markov fields may be used as the first and/or second machine learning system.

In some embodiments, the fusion unit is based on a Bayesian fusion method, in particular a Kalman filter, for example an extended or unscented Kalman filter, a multi-model filter, for example an interacting multiple model filter, a filter based on random finite sets, or a particle filter. These filters are in turn coupled in particular to an adequate data association method, for example, a probabilistic data association method. Thus, the inferred sensor models may be used directly by the fusion unit. Bayesian fusion methods may be used very flexibly and are thus also easily adaptable to new sensor data. Alternatively, the fusion unit is based on a Dempster-Shafer fusion method, fuzzy logic, probabilistic logics, the random finite set method, or deep neural networks.

In some embodiments, a first fallback sensor model is defined. This first fallback sensor model is based only on the first sensor data and may even be completely independent of the sensor data set. In the latter case, the first fallback sensor model is static and thus situation-independent. The first fallback sensor model is used instead of the first sensor model if the first uncertainty data set is incorrect and/or incomplete. Such incorrectness and/or incompleteness of the first uncertainty data set may occur, for example, if one of the sensors on which the first uncertainty data set is based malfunctions or fails completely. In such a case, the first sensor model will likewise have errors or it will be impossible to generate the first sensor model. In order to still ensure the functioning of the fusion unit, the first fallback sensor model is used. Since this sensor model is based only on the first sensor data, which is also used to generate the first sensor result, or is completely independent of the sensor data set, generation or use of the fallback sensor model is always possible. Thus, the first and second sensor results may still be merged to form the fusion result, meaning that systems based on the fusion result may still be executed.

In some embodiments, the fusion result is an environment model, in particular a vehicle environment model. Environment models include the type and position of objects in the environment of an apparatus with which the first and/or second sensor is associated. This apparatus is, for example, a robot or a vehicle, in particular a semi-autonomous or autonomous vehicle. In order to be able to operate safely, a robot or a semi-autonomous or autonomous vehicle requires accurate knowledge of the objects in its environment, for example a road, stationary objects or other road users, i.e., an accurate environment model. The improved first and/or second sensor model results in an improved fusion result and thus an improved environment model. This leads to improved and in particular safer operation of the robot or the semi-autonomous or autonomous vehicle.

Another aspect relates to a sensor system for merging sensor data. The sensor system includes a first sensor and a signal processing device. The signal processing device receives a sensor data set that includes first sensor data.

Furthermore, the signal processing device includes a first analysis unit, a second analysis unit and a fusion unit. These units may run on different processors but may also be part of an arithmetic unit.

The first analysis unit is designed to analyze the first sensor data. The analysis of the first sensor data includes object detection, for example. Furthermore, the first analysis unit is designed to generate a first sensor result, the first sensor result being based on the analysis of the first sensor data and including, for example, the type and position of the detected objects. Moreover, the first analysis unit is designed to generate a first sensor model associated with the first sensor result. The first sensor model is dependent on a first uncertainty data set that is a subset of the sensor data set. Thus, the first sensor model is not static but is determined dynamically on the basis of sensor data. Thus, the sensor model is continuously adapted to the current situation detected by sensors. A dynamic, situation-adaptive sensor model of this kind describes the uncertainties and probabilities in the detection better than a static sensor model because the dynamic model processes even more information.

The second analysis unit is designed to generate a second sensor result; the second sensor result may be based on the analysis of the first sensor data or on the analysis of further sensor data. Furthermore, the second analysis unit is designed to generate a second sensor model associated with the second sensor result.

The fusion unit is designed to merge the first sensor result and the second sensor result to form a fusion result. This merging is performed on the basis of the first sensor model and the second sensor model. Because the first sensor model is dynamic and situation-adaptive and thus improved, the fusion result is also improved.

In some embodiments, the sensor system is designed to carry out the method for merging sensor data according to the preceding description. Advantageous embodiments of the sensor system are derived from the embodiments of the method.

Another aspect of the invention relates to a vehicle including a sensor system according to the preceding description. The vehicle is in particular a semi-autonomous or autonomous vehicle, and the fusion result is a vehicle environment model. The improvement of the fusion result also results in an improvement of the knowledge of the environment of the vehicle, meaning that functions of the vehicle, in particular semi-autonomous or autonomous driving, may be performed better and in particular more safely.

### BRIEF DESCRIPTION OF THE DRAWINGS

For further clarification, the invention is described with reference to embodiments illustrated in the drawings. These embodiments are to be understood only as examples and not as limitations.

In the drawings:

FIG. 1a shows a flowchart of an exemplary embodiment of a method for merging sensor data;

FIG. 1b shows one example of a method for merging sensor data;

FIG. 1c shows another example of a method for merging sensor data;

FIG. 2a shows a flowchart of another exemplary embodiment of a method for merging sensor data;

FIG. 2b shows yet another example of a method for merging sensor data;

FIG. 3 shows a flowchart of yet another exemplary embodiment of a method for merging sensor data;

FIG. 4 shows a flowchart of yet another exemplary embodiment of a method for merging sensor data; and

FIG. 5 is a schematic view of a vehicle.

### DETAILED DESCRIPTION

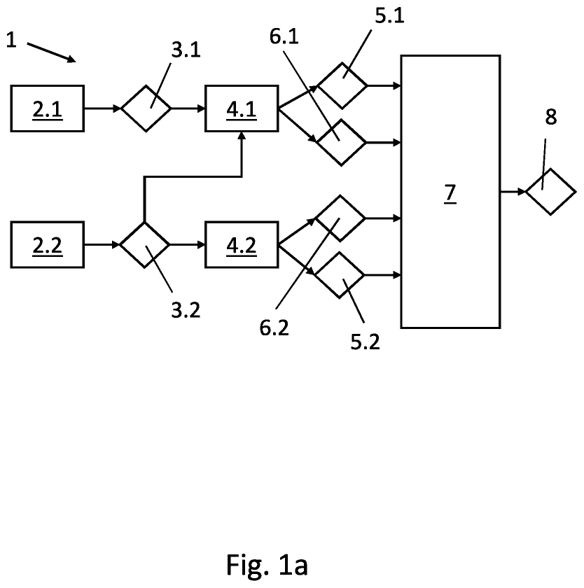

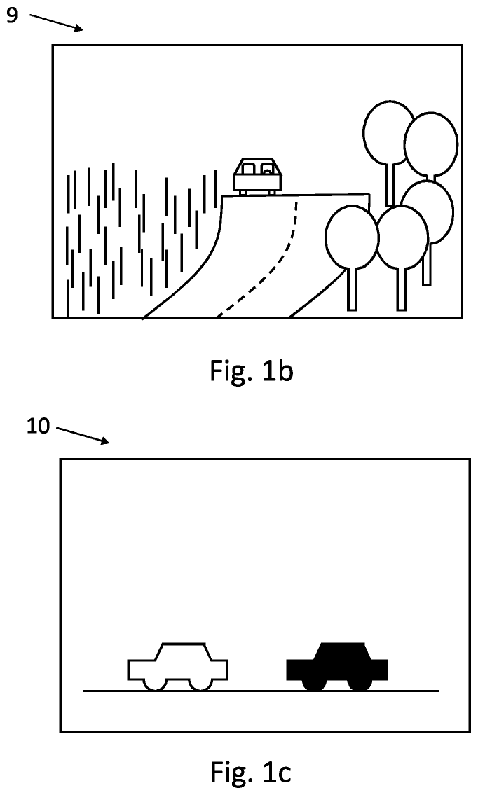

FIG. 1a shows a flowchart of a method 1 for merging sensor data. A first sensor 2.1 acquires raw data 3.1, and a second sensor 2.2 acquires raw data 3.2.

The raw data 3.1 is analyzed by a first analysis unit 4.1. The result of this analysis is a first sensor result 5.1. Furthermore, the first analysis unit 4.1 generates a first sensor model 6.1 that quantifies the uncertainty in the first sensor result 5.1. Moreover, to generate this first sensor model 6.1, raw data 3.2 from the second sensor 2.2 is used. In this way, valuable information that improves the first sensor model 6.1 is processed. The first sensor result 5.1 and the first sensor model 6.1 are then transferred to a fusion unit 7.

Furthermore, the raw data 3.2 from the second sensor 2.2 is analyzed by a second analysis unit 4.2. The result of this analysis is a second sensor result 5.2. Furthermore, the second analysis unit 4.2 generates a second sensor model 6.2. In this exemplary embodiment, to generate the second sensor model 6.2, only the raw data 3.2 from the second sensor 2.2 is used. However, in an alternative exemplary embodiment not shown here, the raw data 3.1 from the first sensor 2.1 may also be used to generate the second sensor model 6.2. The second sensor result 5.2 and the second sensor model 6.2 are also transferred to the fusion unit 7.

The fusion unit 7 generates a fusion result 8 from the first sensor result 5.1 and the second sensor result 5.2. In this process, the first and second sensor results 5.1 and 5.2 are weighted on the basis of the sensor models 6.1 and 6.2, respectively. Since the first sensor model 6.1 has been improved by using the raw data 3.2 from the second sensor 2.2, the fusion result 8 is also more accurate.

As an example, FIG. 1b shows a camera image 9 as captured by a vehicle while driving. The camera image 9 shows an agricultural field, a road with another road user, and a number of trees. The camera image 9 may be considered to be the raw data 3.2 from the second sensor 2.2. For a radar, which may be considered to the first sensor 2.1, the different areas that may be seen in the camera image 9 provide different uncertainties in the sensor model. For example, the detection of road users on the road is much more accurate in comparison with the detection of the agricultural field or the trees. This information obtained from the camera image 9 thus influences the first sensor model 6.1 of the radar 2.1.

As another example, FIG. 1c shows another camera image 10 as captured by a vehicle while driving. The camera image 10 shows two other road users. The first road user is a white vehicle, and the second road user is a black vehicle. The camera image 10 may again be considered to be the raw data 3.2 from the second sensor 2.2. For a lidar, which may be considered to be the first sensor 2.1, different uncertainties may be expected in the sensor model for the two vehicles since a white vehicle reflects light much better than a black vehicle. Thus, the color information obtained from the camera image 10 affects the first sensor model of the lidar 2.1.

As another example not shown here, information about visibility may be obtained from a camera image. For a lidar, this results in different sensor models, for example for a clear day and a foggy day.

As yet another example, which is also not shown here, conclusions about the nature, in particular materials, of objects may be obtained from a camera image and used to generate the first sensor model 6.1 of a radar 2.1 since different materials reflect the radio waves from the radar 2.1 differently.

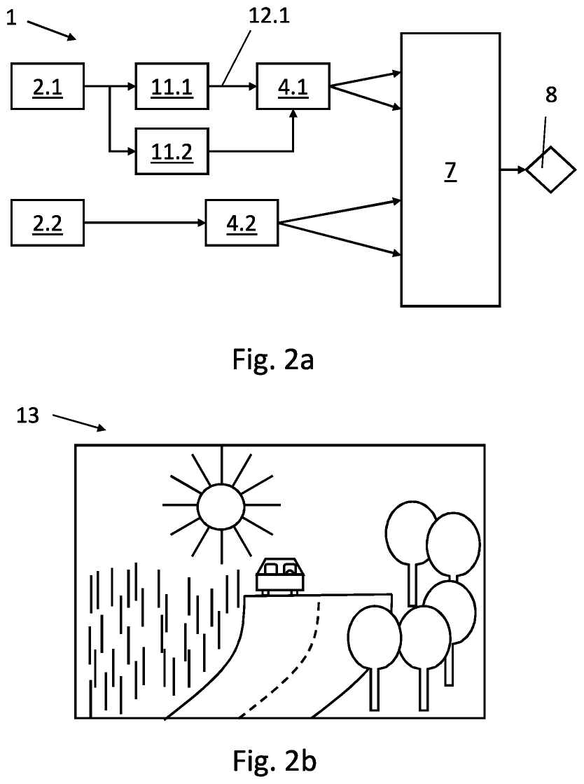

A flowchart of another exemplary embodiment of a method for merging sensor data is shown in FIG. 2a. For the sake of clarity, the raw data 3, sensor results 5 and sensor models 6 are not explicitly shown here.

The raw data 3.1 from the first sensor 2.1 is processed by processing units 11.1 and 11.2. The raw data 3.1 processed by the processing unit 11.1 is transmitted as first sensor data 12.1 to the first analysis unit 4.1 and analyzed by the first analysis unit. To generate the first sensor model 6.1, the first analysis unit 4.1 also uses the raw data 3.1 processed by the processing unit 11.2. This also improves the sensor model 6.1, which leads to an improvement in the fusion result 8.

As an example, FIG. 2b shows another camera image 13 as captured by a vehicle while driving. In comparison with the camera image 9, the low sun may still be seen in this case. The first processing unit 11.1 is, for example, a detector for other road users, and the second processing unit 11.2 is a detector for the low sun. The results from the detector 11.2 for the low sun are used to generate the first sensor model 6.1. If, as in this example, the low sun is visible in the image, the uncertainty in the detection of road users by the camera 2.1 is increased. However, the low sun does not affect a radar 2.2. Thus, in the fusion, the first sensor results 5.1 will have a smaller weighting than the second sensor results 5.2.

While a camera image is always used to generate the first sensor model 6.1 in the examples shown here, data from other sensors, such as a radar, lidar or ultrasound, may also be used to generate the first sensor model 6.1. However, by using the camera image, the method may be illustrated in the most intuitive manner.

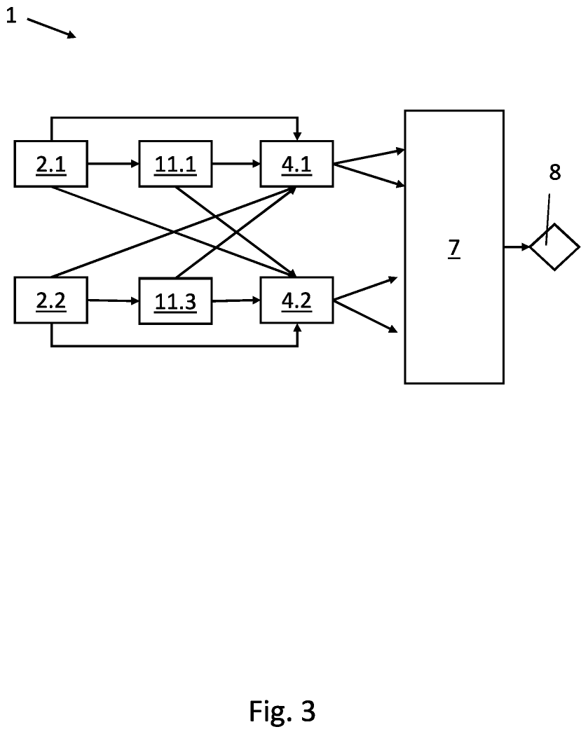

A flowchart of yet another exemplary embodiment of a method for merging sensor data is shown in FIG. 3. In this case, the first sensor result 5.1 is generated by the first analysis unit 4.1 on the basis of the raw data 3.1 from the first sensor 2.1 that is processed by the processing unit 11.1. To generate the first sensor model 6.1, the raw data 3.1 from the first sensor 2.1, the raw data 3.2 from the second sensor 2.2 and the raw data 3.2 from the second sensor 2.2 that is processed by a further processing unit 11.3 are additionally used.

Likewise, the second sensor result 5.2 is generated by the second analysis unit 4.2 on the basis of the raw data 3.2 from the second sensor 2.2 that is processed by the processing unit 11.3. To generate the second sensor model 6.2, the raw data 3.2 from the second sensor 2.2, the raw data 3.1 from the first sensor 2.2 and the raw data 3.1 from the first sensor 2.1 that is processed by the processing unit 11.1 are additionally used. The thus improved sensor models 6.1 and 6.2 lead to a further improved fusion result 8.

While this exemplary embodiment is limited to two sensors 2.1 and 2.2, the method may also be easily extended to a larger number of sensors 2. For example, cameras, a radar, a lidar or ultrasonic sensors may be used as sensors.

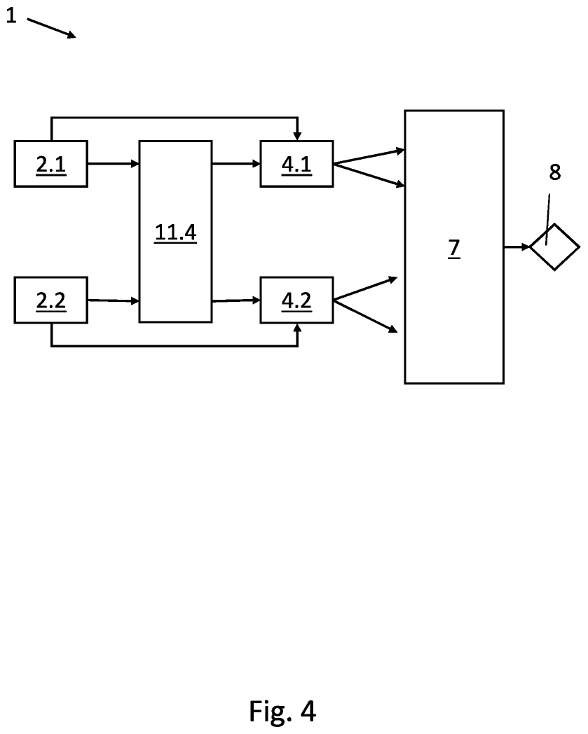

A flowchart of yet another exemplary embodiment of a method for merging sensor data is shown in FIG. 4. In this case, a processing unit 11.4 processes the raw data 3.1 and 3.2 from the sensors 2.1 and 2.2, respectively. As an intermediate step, a processing unit 11.4 of this kind may, for example, generate an occupancy grid that describes the occupancy of spatial points by objects. From this occupancy grid, the individual objects may in turn be detected, for example other road users, lanes or free spaces. However, to determine the sensor models 6.1 and 6.2, the raw data 3.1 and 3.2 from the sensors 2.1 and 2.2, respectively, is used.

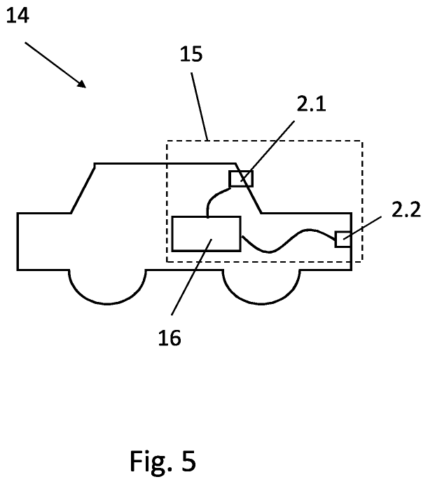

FIG. 5 shows a vehicle 14 having a sensor system 15. The sensor system 15 comprises the first sensor 2.1, the second sensor 2.2 and a signal processing device 16, which carries out the above-described method. A vehicle 14 equipped in this way offers increased safety, in particular for semi-autonomous or autonomous driving, due to the improved fusion results 8.

### LIST OF REFERENCE NUMERALS

1 Method for merging sensor data
2.1 First sensor
2.2 Second sensor
3.1 Raw data from the first sensor 2.1
3.2 Raw data from the second sensor 2.2
4.1 First analysis unit
4.2 Second analysis unit
5.1 First sensor result
5.2 Second sensor result
6.1 First sensor model
6.2 Second sensor model
7 Fusion unit
8 Fusion result
9 Camera image
10 Camera image
11 Processing units
12.1 First sensor data
13 Camera image
14 Vehicle
15 Sensor system
16 Signal processing device

1. A method for merging sensor data, comprising:
providing a sensor data set including first sensor data;
analyzing the first sensor data, generating a first sensor result and generating a first sensor model from a first analysis unit, the first sensor result being based on the analysis of the first sensor data, the first sensor model being associated with the first sensor result and being dependent on a first uncertainty data set, the first uncertainty data set being a subset of the sensor data set;
generating a second sensor result and generating a second sensor model from a second analysis unit, the second sensor model being associated with the second sensor result; and
merging the first sensor result and the second sensor result to form a fusion result from a fusion unit, the merging being performed on the basis of the first sensor model and the second sensor model.

2. The method according to claim 1, wherein the first sensor data includes at least on of raw data from a first sensor or processed raw data from at least the first sensor.

3. The method according to claim 1, wherein the sensor data set includes second sensor data, and the method further comprises:
analyzing the second sensor data, wherein the second sensor result is based on the analysis of the second sensor data, and in particular the second sensor data includes at least one of raw data from a second sensor or processed raw data from at least the second sensor.

4. The method according to claim 3, wherein at least one of the first sensor or the second sensor is from a group consisting of a camera, radar, lidar and an ultrasonic sensor.

5. The method according to claim 3, wherein the first uncertainty data set is different from the first sensor data and/or wherein the first uncertainty data set includes at least one from a group consisting of raw data from the first sensor, raw data from the second sensor, processed raw data from at least the first sensor, and processed raw data from at least the second sensor.

6. The method according to claim 3, wherein the second sensor model is dependent on a second uncertainty data set, wherein the second uncertainty data set is a subset of the sensor data set, which is in particular different from the second sensor data, and in particular includes at least one from a group, the group consisting of raw data from the first sensor, raw data from the second sensor, processed raw data from at least the first sensor, and processed raw data from at least the second sensor.

7. The method according to claim 1, wherein the first sensor model and/or the second sensor model include at least one from a group consisting of a statistical measurement uncertainty, a classification uncertainty, a detection probability and a false alarm rate.

8. The method according to claim 1, wherein the generation of at least one of the first sensor model or the second sensor model is performed by an algorithm that is dependent on at least one of the first uncertainty data set or the second uncertainty data set, respectively.

9. The method according to claim 1, wherein the generation of the first sensor model is performed by a trained first machine learning system, and/or the generation of the second sensor model is performed by a trained second machine learning system.

10. The method according to claim 9, wherein the first machine learning system and/or the second machine learning system is from a group including a deep neural network, probabilistic graphical models, Bayesian networks and Markov fields.

11. The method according to claim 1, wherein the fusion unit is based on a Bayesian fusion method, in particular a Kalman filter, a multi-model filter, a filter based on random finite sets or a particle filter, in particular in conjunction with a data association method, on a Dempster-Shafer fusion method, on fuzzy logic, on probabilistic logics, on the random finite set method or on deep neural networks.

12. The method according to claim 1, wherein a first fallback sensor model is defined, which is independent of the sensor data set and/or based only on the first sensor data, and if the first uncertainty data set is incorrect and/or incomplete, the first fallback sensor model is used instead of the first sensor model.

13. The method according to claim 1, wherein the fusion result is an environment model, in particular a vehicle environment model.

14. A sensor system for merging sensor data, comprising
a first sensor; and
a signal processing device, comprising:
a first analysis unit which is configured to analyze first sensor data, and to generate a first sensor result and a first sensor model associated with the first sensor result, the first sensor model being dependent on a first uncertainty data set, which is a subset of a sensor data set;
a second analysis unit which is configured to generate a second sensor result and a second sensor model associated with the second sensor result; and
a fusion unit which is configured to merge the first sensor result and the second sensor result, on the basis of the first sensor model and the second sensor model, to form a fusion result.

15. A vehicle, comprising the sensor system according to claim 14.
